(19) United States
(12) Patent Application Publication
(10) Pub. No.: US 2010/0326400 A1
(43) Pub. Date: Dec. 30, 2010

(54) High Efficiency Pre-Chamber Internal Combustion Engines and Methods Thereof

(75) Inventor: Marvin F. Hayes, JR., Hesperia, CA (US)

Correspondence Address: Workman Nydegger;1000 Eagle Gate Tower, 60 East South Temple, Salt Lake City, UT, 84111, US

(73) Assignee: HAYES DIVERSIFIED TECHNOLOGIES, INC., Hesperia, CA (US)

(21) Appl. No.: 12/818,772

(22) Filed: Jun. 18, 2010

Related U.S. Application Data
(60) Provisional application No. 61/222,004, filed on Jun. 30, 2009.

(51) Int. Cl. F02F 3/26

(52) U.S. Cl. 123/279; 123/193.6

(57) ABSTRACT

Inventive embodiments are directed to components, subassemblies, systems, and/or methods for internal combustion engines and in particularly for diesel engines having prechamber combustion systems. In one embodiment, a combustion system can be provided with a pre-chamber adapted to cooperate with a piston in a manner that produces a highly efficient combustion process. In some embodiments, the pre-chamber has passages that have a variable cross-section and a variable angular orientation with respect to a centerline of the pre-chamber body. In one embodiment, the piston is provided with a number of surfaces that facilitate the flow of fuel and air within the combustion chamber. In some embodiments, the piston surfaces are generally aligned with angles of the combustion chamber such as the angle of the intake and exhaust valves. In other embodiments, the piston has surfaces that are adapted to cooperate with a tip of the prechamber.

### CROSS-REFERENCE TO RELATED APPLICATIONS

This application claims benefit to U.S. Provisional Application No. 61/222,004, filed Jun. 30, 2009, which is incorporated herein by specific reference.

### BACKGROUND OF THE INVENTION

1. The Field of the Invention

The field of the invention relates generally to internal combustion engines and more particularly to diesel engines having a pre-combustion chamber and pistons used therewith.

2. The Relevant Technology

Two fundamentally different combustion systems are used today for diesel engines. One is the open-chamber or direct injection (DI) system and the other is a divided chamber or indirect injection system (IDI). In the DI system, high-pressure fuel is delivered by fuel injectors at the end of the compression stroke directly into the combustion chamber formed on the top of the piston. Fuel injection components for DI systems are costly and certain components, such as the high pressure fuel pumps, contribute a significant accessory load on the engine.

Many forms of diesel engines use IDI or precombustion chambers (sometimes referred to as “prechamber systems”) to assist in the combustion process. Prechambers are generally smaller volume chambers than the main combustion chamber and are in fluid communication with the main combustion chamber through a number of passages. The fuel is injection into the prechamber where ignition begins. A burning mixture of air and fuel enters the main combustion chamber along with additional fuel through the prechamber passages. Combustion is generally lean of stoichiometric air-fuel ratio for typical prechamber systems, which results in highly fuel efficient engine systems.

In recent years, diesel engines using IDI systems have been developed to achieve higher speeds than their predecessors. For example, U.S. Pat. Nos. 5,924,402 and 6,854,439 disclose advancements in IDI and, in particularly, pre-chamber technology. However, the advancements in pre-chamber geometry presented by these references are limited by the piston geometry typical in diesel engines.

Some development has been undertaken to apply pre-chamber diesel technology to gasoline motorcycle engines. For example, the technical paper SAE982051 published by the Society of Automotive Engineers in 1998 describes a single cylinder 547 cm³ displacement engine that was outfitted with a 4-valve pent-roof combustion system having a pre-chamber centrally located in the pent-roof.

Lean burning diesel engines typically suffer from poor emissions. For example, diesel engine prechamber combustion systems often have high emissions of oxides of nitrogen (sometimes referred to here as “NOx”), which contribute to smog and are known carcinogens. NOx emissions are largely controlled by managing combustion temperatures in the main combustion chamber. This is a challenge for modern prechamber combustion systems that are configured to have highly heterogeneous combustion of fuel and air in the main combustion chamber. Therefore, there is a need for a prechamber combustion system that improves control of combustion and eliminates the need for costly high-pressure DI fuel systems.

### BRIEF DESCRIPTION OF THE DRAWINGS

Various embodiments of the present invention will now be discussed with reference to the appended drawings. It is appreciated that these drawings depict only typical embodiments of the invention and are therefore not to be considered limiting of its scope.

FIG. 1 is a perspective view of an inventive embodiment of a combustion system having a pre-chamber and piston;

FIG. 2 is a plan view of one embodiment of a pre-chamber that can be used with the combustion system of FIG. 1;

FIG. 3 is a cross-sectional view A-A of the pre-chamber of FIG. 2;

FIG. 3A is a plan view of the tip shown in FIG. 2;

FIG. 3B is a plan view of an alternative embodiment the tip shown in FIG. 3A wherein the passage has a circular opening on the exterior surface;

FIG. 4 is a cross-sectional view B-B of the pre-chamber of FIG. 2;

FIG. 5 is a cross-sectional view C-C of the pre-chamber of FIG. 2;

FIG. 6 is a perspective view of an embodiment of a piston that can be used with the combustion system of FIG. 1;

FIG. 7 is a cross-sectional view of the piston of FIG. 6;

FIG. 8 is another cross-sectional view of the piston of FIG. 6;

FIG. 9 is a detail view A of the piston of FIG. 6;

FIG. 9A is a cross-section view D-D of the side ramp shown in FIG. 6;

FIG. 10 is a perspective view of another embodiment of a piston that can be used with the combustion system of FIG. 1;

FIG. 11 is a cross-sectional view of the piston of FIG. 10;

FIG. 12 is another cross-sectional view of the piston of FIG. 10;

FIG. 13 is a perspective view of yet another embodiment of a piston that can be used with the combustion system of FIG. 1;

FIG. 14 is a cross-sectional view of the piston of FIG. 13;

FIG. 15 is another cross-sectional view of the piston of FIG. 13;

FIG. 16 is a perspective view of another embodiment of a piston that can be used with the combustion system of FIG. 1;

FIG. 17 is a cross-sectional view of the piston of FIG. 16;

FIG. 18 is another cross-sectional view of the piston of FIG. 16;

FIG. 19 is a perspective view of another embodiment of a piston that can be used with the combustion system of FIG. 1;

FIG. 20 is an enlarged perspective view of the termination of the outside ramp shown in FIG. 19;

FIG. 21 depicts a graph illustrative of the performance of the combustion system of FIG. 1; and

FIG. 22 depicts a table summarizing the exhaust emission emitted from the combustion system of FIG. 1.

### DETAILED DESCRIPTION OF THE PREFERRED EMBODIMENTS

The preferred embodiments will be described now with reference to the accompanying figures, wherein like numerals refer to like elements throughout. The terminology used in the descriptions below is not to be interpreted in any limited or restrictive manner simply because it is used in conjunction with detailed descriptions of certain specific embodiments of the invention. Furthermore, embodiments of the invention can include several novel features, no single one of which is solely responsible for its desirable attributes or which is essential to practicing the inventions described.

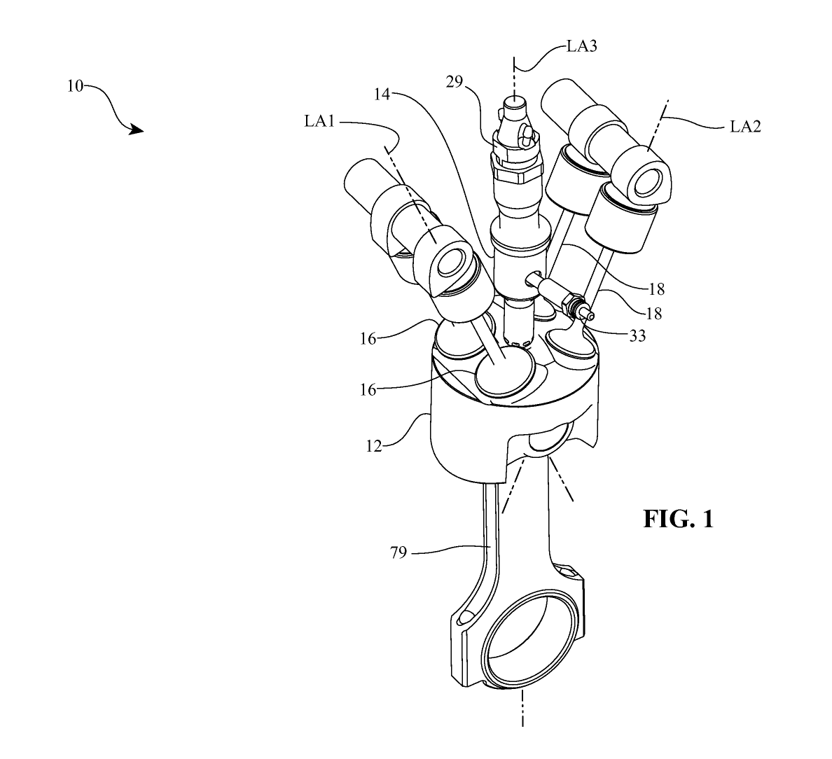

Referring now to FIG. 1, in one embodiment a combustion system 10 includes a piston 12 configured to cooperate with a pre-chamber 14 and a number of intake and exhaust valves 16, 18, respectively. Intake valves 16 and exhaust valves 18 are each shown having a central longitudinal axis LA1 and LA2 extending therethrough, respectively. For clarity purposes, the combustion system 10 is depicted outside of an engine structure. It should be readily apparent to a person having ordinary skill in the relevant technology that the engine structure provides an enclosure for the combustion system 10. The engine structure also supports the basic reciprocating functions of an internal combustion engine such as piston and valve motion, for example.

Typically, the engine structure includes an engine block and/or crankcase having cylinder bores adapted to receive one or more pistons, a cylinder head adapted to receive the intake and exhaust valves 16, 18, and associated hardware to support engine operation, such as coolant passages, oil passages, and fuel delivery systems, among other things. For example, FIG. 7 illustrates piston 12 disposed within a cylinder bore 130 of an engine block 132. Piston 12 and cylinder bore 130 partially bound a combustion chamber 134. For description purposes, a combustion chamber is considered the volume enclosed by the cylinder bore, the piston, and the cylinder head. In most cases, the geometric shape of the cylinder head can be depicted by the arrangement of the intake and exhaust valves 16, 18. The combustion system 10 can be implemented in a variety of engine structures. In one embodiment, the Kawasaki KLR650 engine structure can be used in conjunction with the combustion system 10 or any of the embodiments of combustion systems described here. It should be noted, however, that the combustion system 10 can be scaled appropriately to accommodate a variety of engine displacements, compression ratios, and valve-train systems.

Referring still to FIG. 1, the pre-chamber 14 is coupled with a fuel injector 29 and a glow plug 33. Pre-chamber 14 can be surrounded by the intake valves 16 and exhaust valves 18. In the embodiment depicted, the pre-chamber 14 has a central longitudinal axis LA3 extending therethrough. The longitudinal axis LA3 can also correspond to the central longitudinal axis of piston 12 and the central longitudinal axes of a cylinder bore (not shown) in which the piston 12 reciprocates. In other embodiments, the longitudinal axis LA3 of pre-chamber 14 is aligned parallel to but is off-set a distance from the longitudinal axis LA3 of the piston 12 so that the axes are not co-linear. The central longitudinal axes LA1 and LA2 of the intake valves 16 and the exhaust valves 18 are typically arranged angularly with respect to the longitudinal axis LA3. The intake valves 16 typically have a larger diameter than exhaust valves 18.

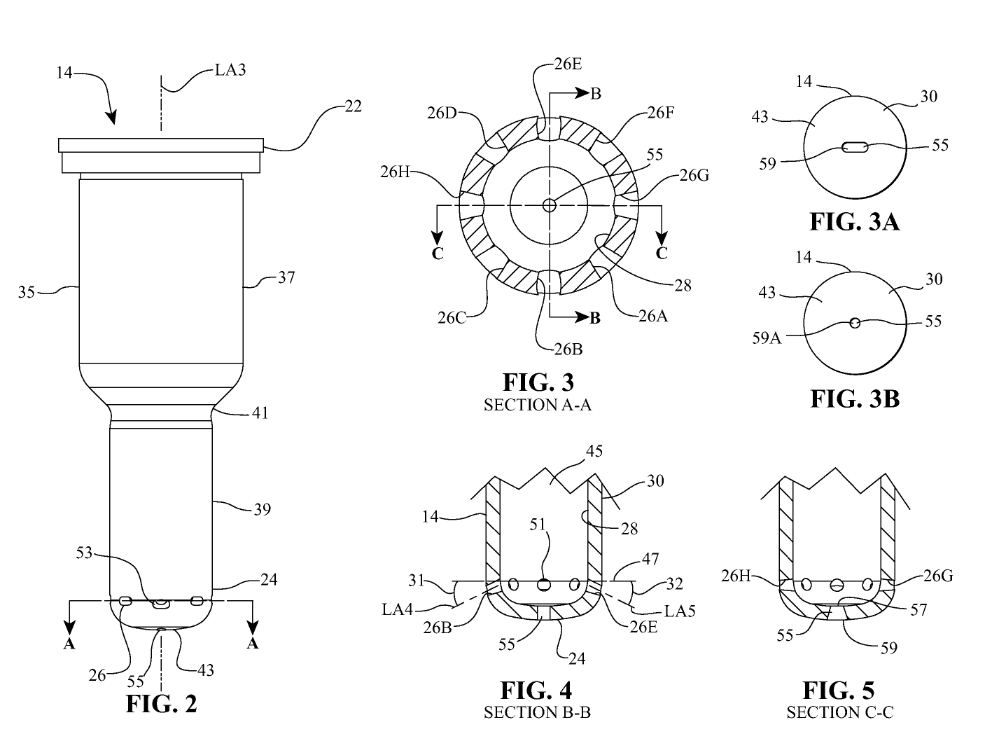

Turning now to FIGS. 2-5, in one embodiment pre-chamber 14 is a substantially hollow body having an encircling sidewall 35 extending between an open end 22 and an opposing tip 24. Tip 24 terminates at a terminal end face 43. Sidewall 35 includes a cylindrical first portion 37 disposed toward open end 22 and a cylindrical second portion 39 disposed toward tip 24, second portion 39 having an outside diameter smaller than the outside diameter of first portion 37. A tapered shoulder 41 is formed between portions 37 and 39. In alternative embodiments, sidewall 35 can have a uniform transverse cross section along the length thereof or can gradually taper along the length thereof. Pre-chamber 14 also has an interior surface 28 that bounds a compartment 45 (FIG. 4) and an opposing exterior surface 30.

The open end 22 is adapted to mate with components of a fuel delivery system, such as a fuel injector 31 (FIG. 1). The tip 24 is located on the interior of the combustion chamber. The tip 24 can be provided with a number of first passages 26 arranged radially about the longitudinal axis LA3. The first passages 26 extend between interior surface 28 and exterior surface 30 of the pre-chamber 14. In one embodiment, the first passages 26 are formed with a substantially circular opening 51 on the interior surface 28 and an elongated opening 53 on the exterior surface. The transverse cross-sectional shape of the first passages 26 can transition from a circular cross-section on or adjacent to the interior surface 28 to an elongated cross-section on or adjacent to the exterior surface 30. The elongated transverse cross-section can be elliptical, oval, lens shaped, an elongated rectangle with rounded ends or any other elongated shape.

The ratio of the major diameter to minor diameter of the elongated cross-section is typically in the range of about 1.25 to about 1.75 with the ratio most commonly being greater than 1.25. Other ratios can also be used. In the above embodiment, the cross sectional area of opening 53 is typically larger than the opening of 51. The transitioning of the shape of first passages 26 helps to disperse the combusting fuel/air mixture, as discussed below in greater detail, as it exits out through opening 53, thereby improving combustion efficiency. In alternative embodiments, it is appreciated that both openings 51 and 53 can be circular or elongated, can both be the same shape and size, can both be the same shape but different size, or can be the same size but different shape.

Referring specifically now to FIGS. 3-5, in one embodiment the pre-chamber 14 can be provided with eight first passages 26. The pre-chamber 14 is arranged in the combustion system 10 so that three of the passages 26 (labeled as 26A, 26B, 26C in FIG. 3) are directed towards the intake valves 16, three of the passages 26 (labeled as 26D, 26E, 26F in FIG. 3) are directed towards the exhaust valves 18, and two of the passages 26 (labeled as 26G, 26H in FIG. 3) are arranged between the intake and exhaust valves 16, 18. The passages 26G, 26H are directed to substantially opposite sides of the combustion chamber. In alternative embodiments other numbers of passages 26, such as in a range from six passages to ten passages or more, can also be used. In one embodiment, the first passages 26 are formed at an angle between the interior surface 28 and the exterior surface 30 when viewed in the plane of the page of FIGS. 3-5.

In one embodiment, the first passages 26 are generally aligned with surfaces of the combustion chamber, which can be approximated by the angular position of the intake and exhaust valves 16, 18 with respect to the longitudinal axis LA3 (FIG. 1). For example, the passages 26A, 26B, 26C each have a central longitudinal axis LA4 extending therethrough that can be formed at an angle 31 relative to a plane 47 that extends normal to longitudinal axis LA3 as viewed in FIG. 4. The passages 26A, 26B, 26C are arranged so that central longitudinal axis LA4 can be substantially perpendicular to central longitudinal axis LA1 of an intake valve 16 (FIG. 1). In some embodiments, the passages 26A, 26B, 26C can be at slightly different angles with respect to each other to facilitate, among other things, maintaining a consistent angular orientation with respect to the combustion chamber.

Likewise, the passages 26D, 26E, 26F each have a central longitudinal axis LA5 extending therethrough that can be formed at an angle 32 relative to plane 47 as viewed in FIG. 4. The passages 26D, 26E, 26F are arranged so that central longitudinal axis LA5 can be substantially perpendicular to central longitudinal axis LA2 of an exhaust valve 18 (FIG. 2). In some embodiments, the passages 26D, 26E, 26F can be at slightly different angles with respect to each other to facilitate, among other things, maintaining a consistent angular orientation with respect to the combustion chamber. The angles 31, 32 can be in the range of about 0 degrees to about 45 degrees with about 15 degrees to about 30 degrees being more common. Other angles can also be used. The passages 26G, 26H can be formed substantially horizontal when viewed in the plane of the page of FIG. 5. In one embodiment, the passages 26G, 26H are aligned with the surfaces of the combustion chamber located between the intake and exhaust valves 16, 18.

The first passages 26 are arranged to facilitate the introduction of a combusting fuel/air mixture into the combustion chamber in such a way as to promote high combustion efficiency, that is, to burn the fuel completely during the combustion process. Each first passage 26 can extend linearly through pre-chamber 14 and each first passage 26 can be configured so that each central longitudinal axis of each first passage 26 is substantially aligned from the central longitudinal axis LA3 of pre-chamber 14. Alternatively, the central longitudinal axis of each first passage 26 can be offset from central longitudinal axis LA3.

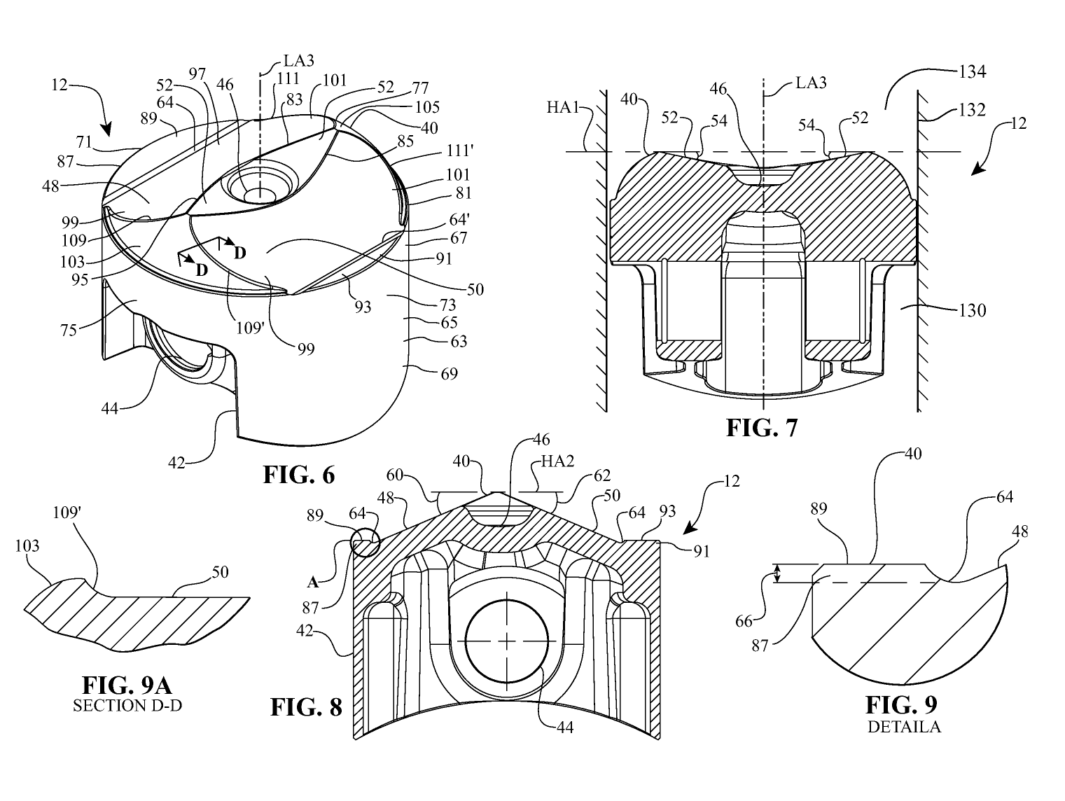

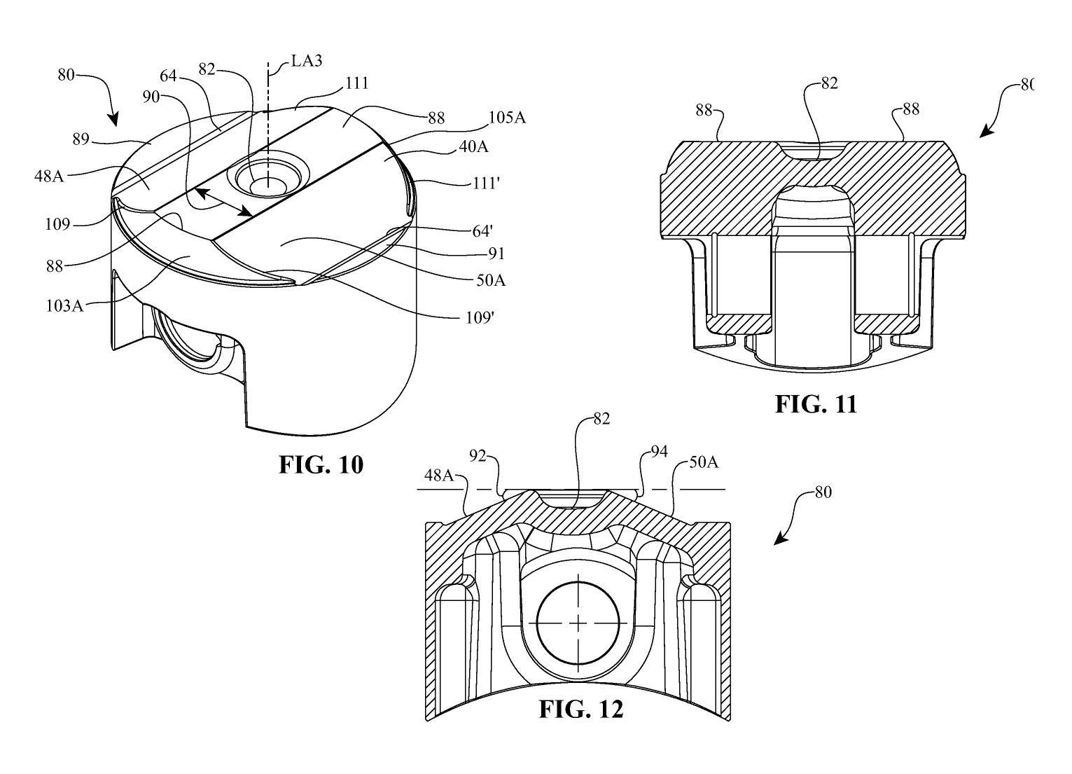

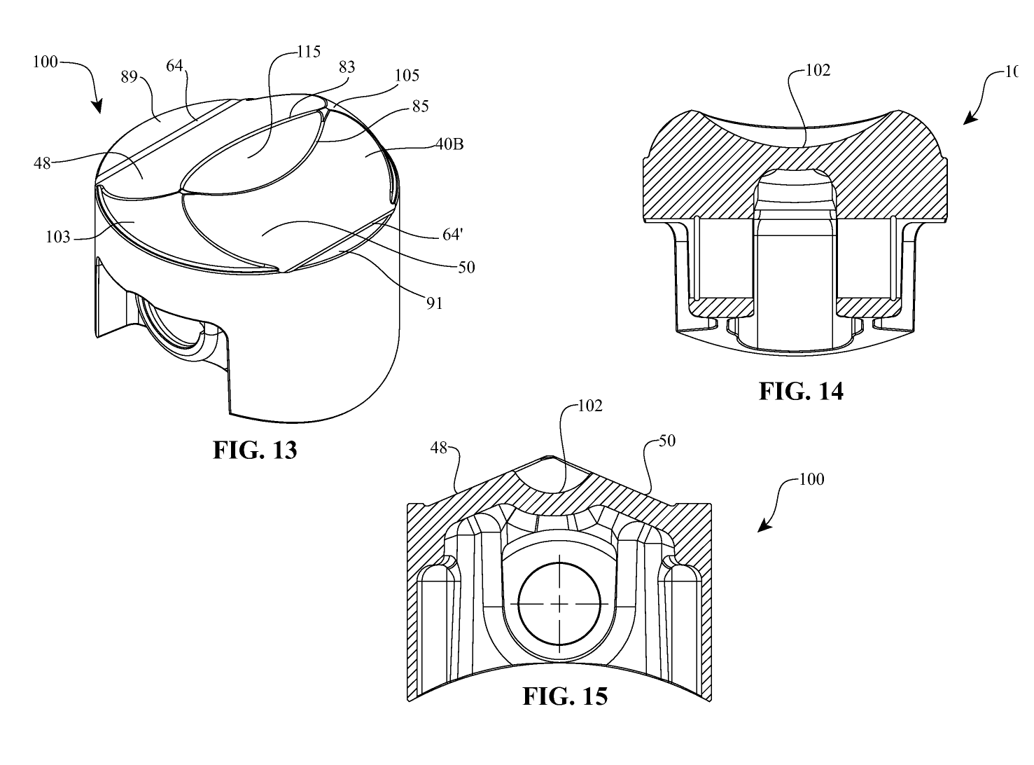

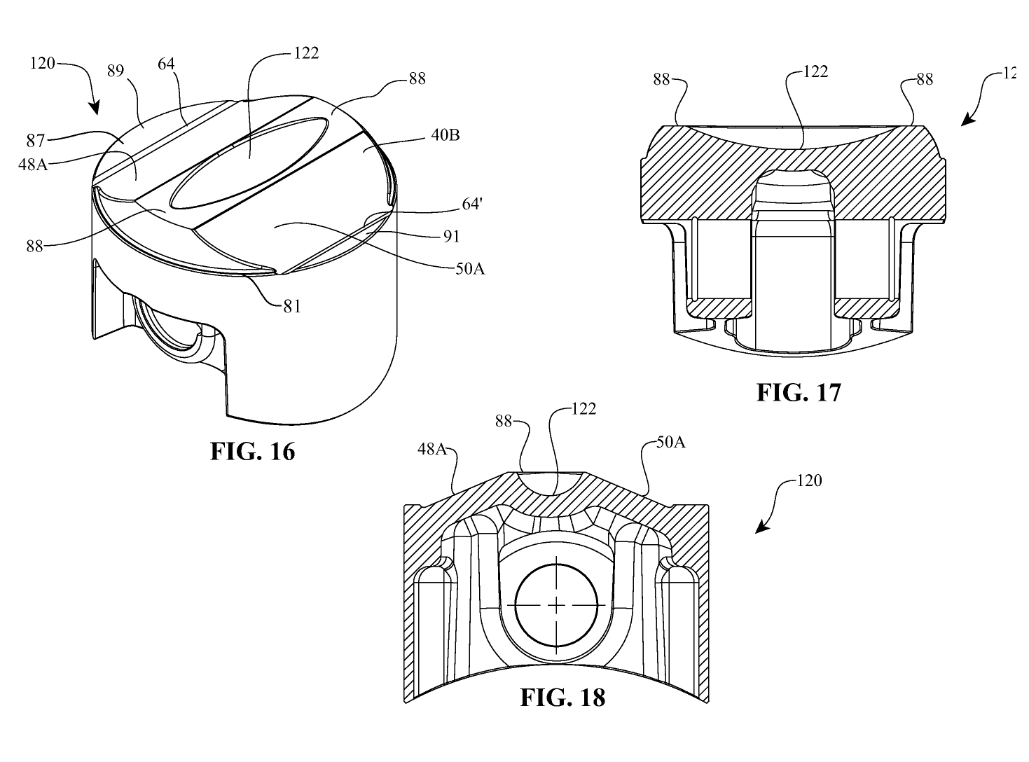

Although not required, in one embodiment a second passage 55 can extend through pre-chamber 14 on terminal end face 43 so as to be aligned with central longitudinal axis LA3. Second passage 55 also has an opening 57 on interior surface 28 and an opening 59 on exterior surface 30. In one embodiment, opening 57 is substantially circular while opening 59 is elongated such as with the shapes as discussed above with regard to opening 53. Thus, the transverse cross-section area of second passage 55 can transfer from substantially circular at or adjacent to interior surface 28 to elongated at or adjacent to exterior surface 30. Likewise, opening 59 can have a larger surface area than opening 57. In other embodiments, openings 57 and 59 can both be circular or elongated, can both be the same shape and size, can both be the same shape but different size or can be the same size but different shape. For example, in FIG. 3A second passage 55 has an elongated opening 59 on exterior surface 30 while in FIG. 3B second passage 55 has a circular opening 59A on exterior surface 30. Accordingly, in FIG. 3B passage 55 can have a frustoconical configuration with circular opening 59A being the larger end. It is appreciated that elongated openings 59 are typically used when the piston has an elongated pre-chamber relief as shown in FIGS. 13 and 16 and that circular opening 59A is typically used within pre-chamber relief is circular as shown in FIGS. 6 and 10. However, circular opening 59A is also used with pistons having an elongated pre-chamber relief as shown in FIGS. 13 and 16.

Passing now to FIGS. 6-9, in one embodiment, the piston 12 comprises a substantially cylindrical body 63 having an exterior surface 65 extending between a first end 67 and an opposing second end 69. For ease in reference, body 63 is generally described as having a front face 71 and an opposing back face 73 with opposing side faces 75 and 77 extending therebetween. The piston 12 can be provided with a wrist-pin bore 44 that transversely extends through body 63 between the opposing side faces 75 and 77. The wrist-pin bore 44 extends generally perpendicular to the longitudinal axis LA3. Wrist pin bore 44 is used for coupling a piston rod 79 (FIG. 1) to piston 12 so that piston rod 79 projects from second end 69. For clarity purposes, the piston 12 is depicted without ring grooves typically formed on the outer circumference of engine pistons. It should be understood that the piston 12 can be provided with a number of ring grooves and/or oil passages, among other things.

First end 67 of piston 12 terminates at a terminal end face on which a crown 40 is formed. Crown 40 extends to a perimeter edge 81 and can have a variety of different configurations. In the embodiment depicted, crown 40 comprises a central plateau surface 52 in the form of a lens that longitudinally projects in alignment with wrist-pin bore 44, i.e., projects towards opposing side surfaces 75 and 77. Central plateau surface 52 includes an arced front edge 83 disposed toward front face 71 and an arced back edge 85 disposed toward back face 73. The edges 83 and 85 intersect at a point or are adjacently disposed at their opposing ends.

Centrally recessed on central plateau surface 52 is a pre-chamber relief 46. Pre-chamber relief 46 has a bowl shaped configuration with a substantially circular transverse cross section. Pre-chamber relief 46 is configured to receive and closely surround the end of tip 25 of pre-chamber 14. Thus, in one embodiment pre-chamber relief 46 can be formed in alignment with central longitudinal axis LA3.

The crown 40 further includes a first ledge 87 formed adjacent to perimeter edge 81 along front face 71 and a second ledge 91 formed adjacent to perimeter edge 81 along back face 73. First ledge 87 has a top surface 89 while second ledge 91 has a top surface 93. In the depicted embodiment, top surfaces 89 and 93 are substantially planar. A first valve relief surface 48 is disposed between plateau surface 52 and first ledge 87 while a second valve relief surface 50 is disposed between plateau surface 52 and second ledge 91. Both valve relief surfaces 48 and 50 are substantially planar and include an inside edge 95 disposed adjacent to plateau surface 52, an outside edge 97 disposed adjacent to ledge 87 or 91, and opposing first and second side edges 99 and 101 extending therebetween. The first valve relief surface 48 is located to be in alignment with the intake valves 16 while the second valve relief surface 50 is located to be in alignment with the exhaust valves 18. A first shoulder surface 103 is formed between the first sided edges 99 of valve relief surfaces 48 and 50 and perimeter edge 81 while a second shoulder surface 105 is formed between second side edges 101 of valve relief surfaces 48 and 50 and perimeter edge 81. Shoulder surfaces 103 and 105 are shown having a convex curvature.

Referring specifically now to FIG. 7, the opposing ends of plateau surface 52 angle down toward pre-chamber relief 46. As such, the opposing ends of plateau surface 52 can each form an angle 54 with respect to a horizontal axis HA1 when viewed in the plane of the page of FIG. 7, i.e., when the horizontal axis HA1 is disposed normal to central longitudinal axis LA3. In one embodiment, the angle 54 can be in the range of about 2 degrees to about 30 degrees with about 4 degrees to about 15 degrees being more common. In some embodiments, the angle 54 is around 10 degrees. Other angles can also be used.

Referring specifically now to FIG. 8, the first and second valve relief surfaces 48, 50 form angles 60 and 62, respectively, with respect to a horizontal axis HA2 when viewed in the plane of the page of FIG. 8. Horizontal axis HA2 can be disposed normal to central longitudinal axis LA3 can also be disposed in the plane of top surface 89 of first ledge 87 and/or top surface 93 of second ledge 91. In one embodiment, the angle 60 and the angle 62 are substantially equal. In some embodiments, the angle 60 and the angle 62 are generally aligned with the angular orientation of the intake valves 16 and the exhaust valves 18, for example. In one embodiment, the angles 60, 62 are in the range of about 5 degrees to about 45 degrees with about 15 degrees to about 30 degrees being more common. In a preferred embodiment, the angles 60, 62 are about 23 degrees. Other angles can also be used.

Referring specifically now to FIG. 9, the crown 40 can be provided with an elongated outside ramp surface 64 that transitions between first valve relief surface 48 and top surface 89 of first ledge 87. Outside ramp surface 64 is shown having a curved transverse cross section that is concave. In one embodiment, the outside ramp surface 64 can have a height 66 extending between first valve relief surface 48 and top surface 89 of first ledge 87 in a range between about 1 mm to about 3 mm with about 1 mm to about 2 mm more common. In one embodiment, the height 66 is about 1.5 mm. Other heights can also be used. The outside ramp surface 64 is aligned substantially parallel to the wrist-pin bore 44 (FIG. 6). During operation of the combustion system 10, the curved ramp surface 64 directs fluid motion of the combusting fuel/air mixture to help improve combustion efficiency.

As shown in FIG. 6, similar to outside ramp surface 64, an elongated first side ramp surface 109 transitions between side edge 99 of first valve relief surface 48 and first shoulder surface 103 and a second side ramp surface 111 transitions between side edge 101 of first valve relief surface 48 and second shoulder surface 105. The same outside ramp surface and side ramp surfaces are formed on corresponding edges of second valve relief surface 50 and are identified by reference characters 64′, 109′ and 111′. As shown in FIG. 9A, both side ramp surfaces 109 and 111 have substantially the same configuration as outer ramp surface 64 and have a curved transverse cross section that is concave.

Turning now to FIGS. 10-12, a piston 80 can be used with the combustion system 10. For description purposes, only the differences between the piston 80 and the piston 12 will be described. In one embodiment, the piston 80 can have a crown 40A. In contrast to crown 40, crown 40A has a plateau surface 88 having an elongated, substantially rectangular configuration that is substantially planar and that is disposed in a plane that is normal to central longitudinal axis LA3. Crown 40A is provided with first and second valve relief surface 48A and 50A and with shoulder surfaces 103A and 105A which have been modified relative to corresponding elements 48, 50, 103, and 105 to accommodate for the new shape of plateau surface 88. In one embodiment, the plateau surface 88 can have a width 90 that is substantially equivalent to the diameter of the pre-chamber relief 82. Alternatively, the width 90 can be larger then the diameter of pre-chamber relief 82. The first and second valve relief surfaces 48A, 50A extend angularly from the surface 88 at angles 92, 94, respectively, when viewed in the plane of the page of FIG. 12. In one embodiment, the angles 92, 94 are in the range of about 5 degrees to about 45 degrees with about 15 degrees to about 30 degrees being more common. In a preferred embodiment, the angles 92, 94 are about 23 degrees. Other angles can also be used.

Passing now to FIGS. 13-15, a piston 100 can be used with the combustion system 10. For description purposes, only the difference between the piston 100 and the piston 12 in FIG. 6 will be described. In one embodiment, the piston 100 has a crown 40B. In contrast to crown 40 of FIG. 6, all or substantially all of plateau 52, has been recessed to form an elongated, lens shaped, pre-chamber relief 115 having opposing edges 83 and 85 as previously discussed. The pre-chamber relief 115 is sized so that a portion of the tip 24 of pre-chamber 14 can be received therein. As previously discussed, in this embodiment where pre-chamber relief 115 is elongated, second passage 55 extending through the end of pre-chamber 14 can be elongated on outside surface 28 so that the elongation of second passage 55 is aligned with the elongation of pre-chamber relief 115.

Turning now to FIGS. 16-18, a piston 120 can be used with the combustion system 10. For description purposes, only the differences between the piston 120 and the piston 80 will be described. In one embodiment, the piston 120 has a crown 40C that is substantially identical to the crown 40A in FIG. 10. The only difference is that circular pre-chamber relief 46 has been modified to form an elongated pre-chamber relief 122. Pre-chamber relief 122 can have a transverse cross section in the form of a lens, oval, ellipse, elongated rectangle with rounded ends, or any other desired elongated configuration.

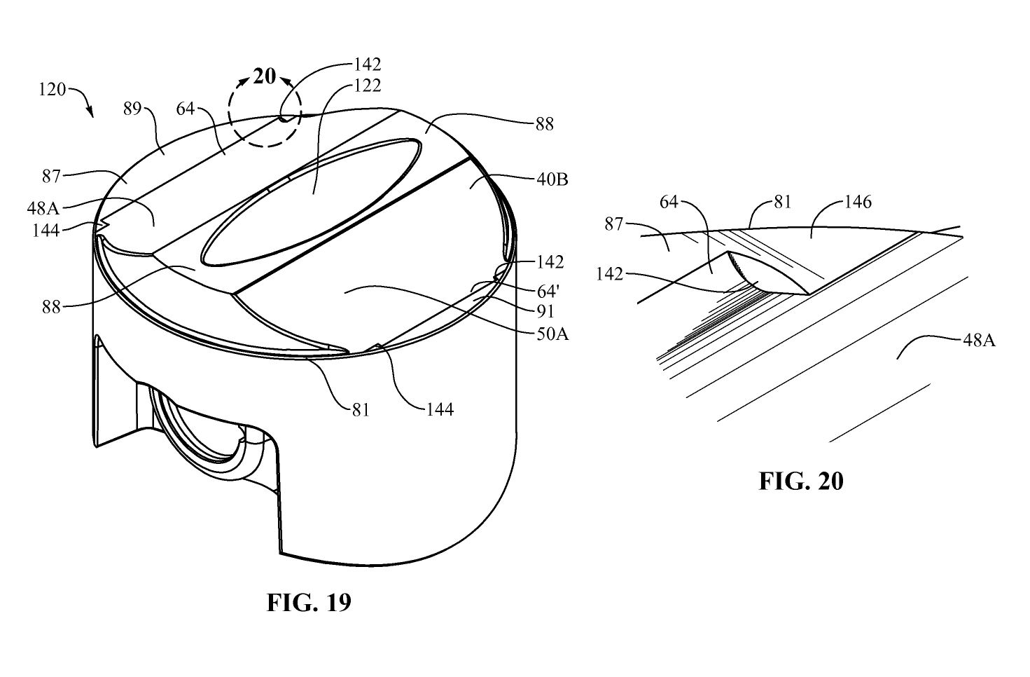

Depicted in FIG. 19 is another alternative embodiment of a piston 140 that can be used with combustion system 10. Like elements between pistons 120 and 140 are identified by like reference characters. As previously discussed with piston 12 (see FIGS. 6 and 9), piston 120 has elongated outside ramp surfaces 64 and 64′ formed adjacent to first ledge 87 and opposing second ledge 91, respectively. Outside ramp surfaces 64 and 64′ each linearly extend between spaced apart locations on perimeter edge 81 and typically have a concave transverse curvature as shown in FIG. 9. As a result of their configuration, each outside ramp surface 64 and 64′ partially bounds a channel that extends along the length thereof. During the combustion stage, outside ramp surfaces 64 and 64′ direct the gases to swirl upward within the combustion chamber to help improve combustion efficiency. However, the gases can also travel laterally within the channels formed by outside ramp surfaces 64 and 64′. These gases can then impinge directly against the cylinder wall and potentially move down the cylinder wall, which can decrease combustion efficiency.

To prevent the gases during combustion from traveling along outside ramp surfaces 64 and 64′ and impinging on the cylinder wall, piston 140 is configured so that outside ramp surfaces 64 and 64′ terminate at a distance before reaching perimeter edge 81. Accordingly, at each opposing end of each outside ramp surface 64 and 64′, first and second valve relief surface 48A and 50A intersect directly with ledges 87 and 91, respectively, adjacent to perimeter edge 81 as shown in FIG. 20.

Expressed in other terms, fillings 142 and 144 can be formed upstanding at opposing ends of each outside ramp surface 64 and 64′ at or adjacent to perimeter edge 81. Fillings 142 and 144 typically have a thickness extending between perimeter edge 81 and the exposed outside ramp surfaces 64 and 64′ in a range between about 1 mm to about 5 mm with about 1.5 mm to about 2 mm being more common. Other dimensions can also be used. Each filling 142 and 144 also has a top surface 146 that can extend flush with ledge 87 or 91 to first or second valve relief surface 48A and 50A, as shown in FIG. 20, or can extend at an angle between ledge 87 or 91 and first or second valve relief surface 48A and 50A. Fillings 142 and 144 can also have other configurations that extend between the valve relief surfaces and the ledges. The object is simply to have fillings 142 and 144 upstanding at the opposing ends of outside ramp surfaces 64 and 64′ so as to help redirect gases traveling along outside ramp surfaces 64 and 64′ and thereby minimize the amount of gas impinging on the cylinder wall at perimeter edge 81. It is appreciated that fillings 142 and 144 can be used in association with outside ramp surfaces 64 and 64′ on all of the other pistons discussed herein.

During operation of the combustion system 10, the piston 12 reciprocates from bottom dead center (BDC) to top dead center (TDC) for every 360 degree revolution of the crankshaft. Pressurized fuel is injected into the pre-chamber 14 before TDC. The timing of the fuel injection with respect to the position of the piston 12 and the opening of the intake valves 16 is dependent upon, among other things, the engine speed, throttle or accelerator pedal opening, for example. In one embodiment, nozzle pop-off pressure for the fuel injector is in the range of about 90 bar to about 160 bar. In other embodiments, the fuel pressure is higher than 160 bar. The opening of the intake valve 16 and the opening of the exhaust valve 18 can be symmetrical or asymmetrical with respect to TDC depending on application and desired performance characteristics of the engine. One advantage of the combustion system 10 is that the opening of the intake and exhaust valves 16, 18 can overlap without introducing excess exhaust products back into the intake valve 16. In one embodiment, the fresh air is substantially equal to atmospheric pressure. In some embodiments, the fresh air is pressurized by a turbocharger or a supercharger. In other embodiments, the fresh air contains a significant content of exhaust products (sometimes referred to as “exhaust gas recirculation” or “EGR”). As the piston 12 approaches TDC the fuel/air mixture inside the pre-chamber 14 ignites. The burning fuel/air mixture along with additional fuel enters the combustion chamber via the first passages 26 and second passage 55. The piston crown, such as crown 40, facilitates the mixing of the fuel and air in a manner that produces highly efficient combustion. The combustion process releases energy that is transferred out of the system as the piston 12 moves towards BDC.

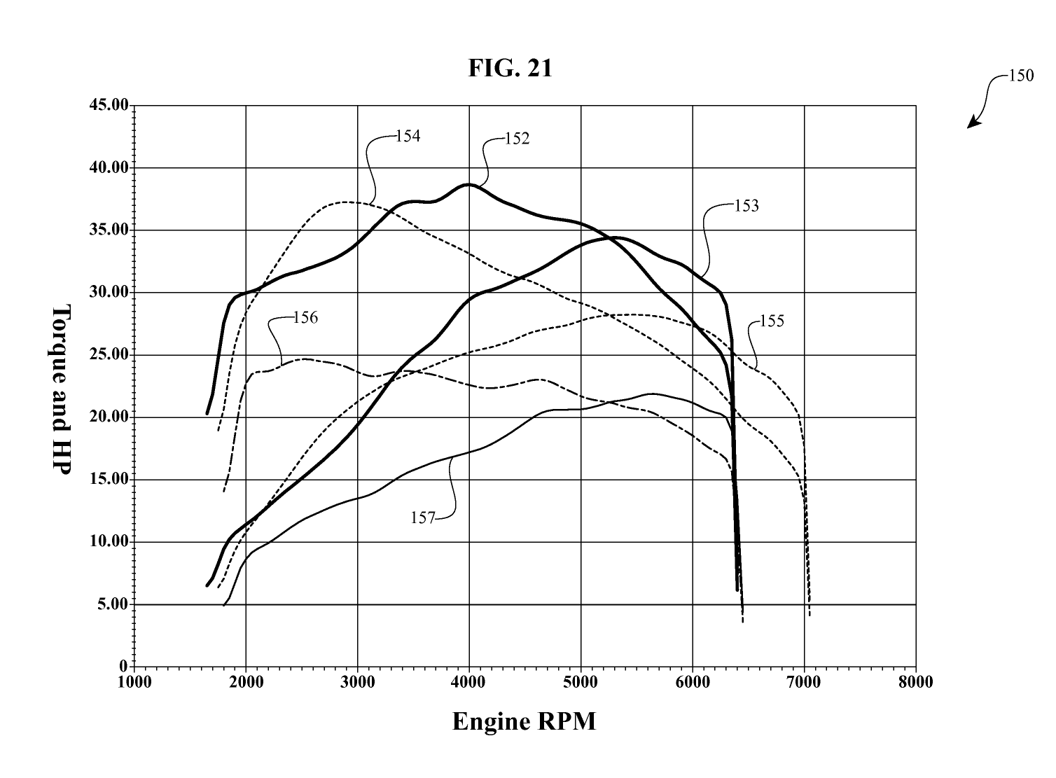

Referring now to FIG. 21, the performance of a motorcycle equipped with an engine having the combustion system 10 is illustrated in graph 150. The x-axis of the graph 150 is the scale for engine speed. The y-axis of the graph 150 is the scale for torque and horsepower. Curve 152 represents the maximum torque produced versus engine speed for a motorcycle engine equipped with the combustion system 10. In one embodiment, the curve 152 is representative of the performance achieved by providing the combustion system 10 with the piston 12 or the piston 100, for example. Curve 153 represents the horsepower corresponding to the curve 152. Curve 154 represents the maximum torque produced versus engine speed for a motorcycle engine equipped with the combustion system 10. In one embodiment, the curve 154 is representative of the performance achieved by providing the combustion system 10 with the piston 80 or the piston 120, for example. Curve 155 represents the horsepower corresponding to the curve 154. Curve 156 represents the maximum torque versus engine speed of a motorcycle engine equipped with a diesel engine of comparable size and structure that is not equipped with the combustion system 10. Curve 157 is the horsepower corresponding to the curve 156. It should be appreciated that the performance provided by the combustion system 10 is significantly higher than the comparable motorcycle diesel engine. The torque and horsepower produced by the combustion system 10 is unexpectedly high and marks a significant advancement in pre-chamber combustion systems for diesel engines. Engines equipped with the combustion system 10 can be used in a variety of applications including, but not limited to, motorized vehicles (including motorcycles, automobiles, airplanes, ships, construction equipment etc.), industrial equipment, and electrical power generation equipment, for example.

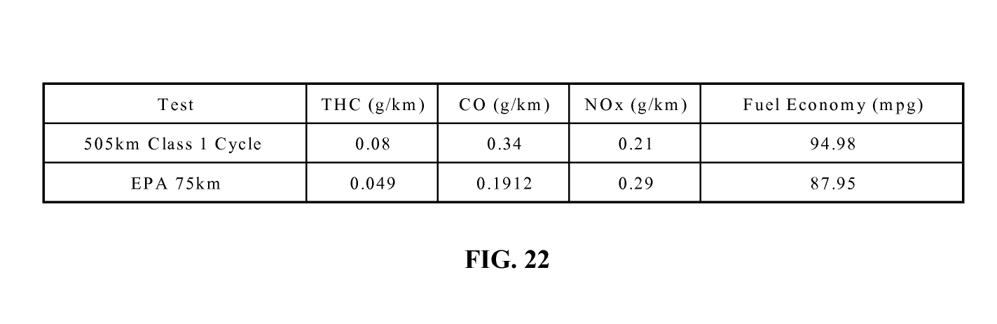

Turning now to FIG. 22, the exhaust emissions produced by a motorcycle equipped with an engine having the combustion system 10 is summarized in the table of FIG. 22. The table of FIG. 22 depicts the results of two standard emissions tests: the 505 km Class 1 Cycle test and the EPA 75 km test. The engine exhaust emission of total hydrocarbon in units of grams per kilometer for each test is labeled as “THC (g/km)” in the table. The engine exhaust emission of carbon monoxide in units of grams per kilometer for each test is labeled as “CO (g/km)” in the table. The engine exhaust emission of oxides of nitrogen in units of grams per kilometer for each test is labeled as “NOx (g/km)” in the table. The average fuel usage in units of miles per gallon of fuel for each test is labeled as “Fuel Economy (mpg)” in the table. Furthermore, a standard opacity test was performed on the exhaust emissions from an engine equipped with the combustion system 10. The opacity test was performed by a Bosch RTT 100 smoke opacimeter. The combustion system 10 produced an average opacity reading of 1.2 BSN (Bosch smoke number). Comparable engines produced an average opacity reading in the range of 13-18 BSN. The legal limit in the state of California is 40 BSN. It should be appreciated that the emissions produced by the combustion system 10 is significantly lower than regulated levels and the fuel economy is higher than would be expected for achieving such low exhaust emissions. These results indicate superior combustion efficiency of the combustion system 10 over the current state of diesel engine technology.

It should be noted that the description above has provided dimensions for certain components or subassemblies. The mentioned dimensions, or ranges of dimensions, are provided in order to comply as best as possible with certain legal requirements, such as best mode. However, the scope of the inventions described herein are to be determined solely by the language of the claims, and consequently, none of the mentioned dimensions is to be considered limiting on the inventive embodiments, except in so far as anyone claim makes a specified dimension, or range of thereof, a feature of the claim.

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated.

What is claimed is:

1. A combustion system for an internal combustion engine having a cylinder bore, an intake valve, and an exhaust valve, the combustion system comprising:
a piston movably positioned within the cylinder bore, the piston having a crown partially bounding a combustion chamber; and
a pre-chamber having an interior surface and an exterior surface each extending between a first end and an opposing second end, the interior surface bounding a compartment, at least a portion of the second end of the pre-chamber being disposed within the combustion chamber, a plurality of first passages extending through the second end of the pre-chamber from the interior surface to the exterior surface, each first passage having a transverse cross sectional area at or adjacent to the exterior surface that is elongated.

2. The combustion system as recited in claim 1, wherein each first passage has a transverse cross sectional area at or adjacent to the interior surface that is substantially circular.

3. The combustion system as recited in claim 1, wherein the elongated transverse cross sectional area of each first passage has a maximum diameter to a minimum diameter ratio in a range between about 1.25 to about 1.75.

4. The combustion system as recited in claim 1, wherein the elongated transverse cross sectional area of each first passage has the shape of an ellipse, oval, or elongated rectangle with rounded ends.

5. The combustion system as recited in claim 1, wherein the elongated transverse cross sectional area at or adjacent to the exterior surface of each first passage is larger than a transverse cross sectional area at or adjacent to the interior surface of each first passage.

6. The combustion system as recited in claim 1, wherein each first passage extends linearly through the pre-chamber.

7. The combustion system as recited in claim 1, wherein the pre-chamber has a central longitudinal axis extending between the first end and the opposing second end, each of the first passages being arranged radially around the central longitudinal axis.

8. The combustion system as recited in claim 7, wherein each first passage has a central longitudinal axis extending therethrough, each central longitudinal axis of each first passage intersecting with the central longitudinal axis of the pre-chamber.

9. The combustion system as recited in claim 7, wherein each first passage has a central longitudinal axis extending therethrough, each central longitudinal axis of each first passage intersecting with a plane disposed normal to the central longitudinal axis of the pre-chamber so as to form an inside angle therebetween in a range between 0° and 45°.

10. The combustion system as recited in claim 7, further comprising a second passage extending through the pre-chamber at the second end, the second passage being aligned with the central longitudinal axis of the pre-chamber.

11. The combustion system as recited in claim 10, the second passage having a transverse cross sectional area at or adjacent to the exterior surface of the pre-chamber that is elongated.

12. The combustion system as recited in claim 10, wherein the second passage has a frustoconical configuration.

13. The combustion system as recited in claim 7, wherein the elongated transverse cross sectional area of at least one of the first passages has a maximum diameter disposed in a plane that is disposed substantially orthogonal to the central longitudinal axis of the pre-chamber.

14. The combustion system as recited in claim 7, wherein the piston further comprises:
a pre-chamber relief recessed on the crown, the pre-chamber relief being aligned with the central longitudinal axis of the pre-chamber;
a first valve relief surface formed on the crown in a first direction from the pre-chamber relief, the first valve relief surface being aligned with the intake valve, the first valve relief surface being substantially planar and disposed within a first plane, the elongated transverse cross sectional area of at least one of the first passages having a maximum diameter disposed in a second plane that is substantially parallel to the first plane; and
a second valve relief surface formed on the crown in a second direction from the pre-chamber relief that is opposite the first direction, the second valve relief surface being aligned with the exhaust valve.

15. The combustion system as recited in claim 1, wherein there are at least six first passages.

16. A combustion system for an internal combustion engine having a cylinder bore, an intake valve, and an exhaust valve, the combustion system comprising:
a piston movably positioned within the cylinder bore, the piston having a crown partially bounding a combustion chamber; and
a pre-chamber having an interior surface and an exterior surface each extending between a first end and an opposing second end, the interior surface bounding a compartment, the pre-chamber having a central longitudinal axis extending through the compartment between the first end and the opposing second end, at least a portion of the second end of the pre-chamber being disposed within the combustion chamber, a plurality of first passages extending through the second end of the pre-chamber radially about the central longitudinal axis, a second passage extending through the second end of the pre-chamber in alignment with the central longitudinal axis, the second passage having an a transverse cross sectional area at or adjacent to the exterior surface of the pre-chamber that is elongated or the second passage has a frustoconical configuration.

17. The combustion system as recited in claim 16, wherein the second passage has a transverse cross sectional area at or adjacent to the interior surface that is substantially circular.

18. The combustion system as recited in claim 16, wherein the second passage has the elongated transverse cross sectional area at or adjacent to the exterior surface and the elongated transverse cross sectional area has a maximum diameter to a minimum diameter ratio in a range between about 1.25 to about 1.75.

19. The combustion system as recited in claim 16, wherein the second passage has the elongated transverse cross sectional area at or adjacent to the exterior surface and the elongated transverse cross sectional area has the shape of an ellipse, oval, or elongated rectangle with rounded ends.

20. The combustion system as recited in claim 16, wherein the second passage has the elongated transverse cross sectional area at or adjacent to the exterior surface and the elongated transverse cross sectional area at or adjacent to the exterior surface of the second passage is larger than a transverse cross sectional area at or adjacent to the interior surface of the second passage.

21. The combustion system as recited in claim 16, wherein the crown of the piston has pre-chamber relief recessed thereon, the pre-chamber relief having a transverse cross sectional area that is elongated and that is aligned with the pre-chamber.

22. The combustion system as recited in claim 21, further comprising:
the piston being movable within cylinder bore between a raised top dead center position and a lowered position; and
the pre-chamber being configured so that when the piston is in the raised top dead center position, at least a portion of the second passage is received within the pre-chamber relief.

23. A combustion system for an internal combustion engine having a cylinder bore, an intake valve, and an exhaust valve, the combustion system comprising:
a piston positioned within the cylinder bore and being movable therein between a raised top dead center position and a lowered position, the piston having a crown with a pre-chamber relief recessed thereon, the pre-chamber relief having a transverse cross sectional area that is elongated; and
a pre-chamber having an interior surface and an exterior surface each extending between a first end and an opposing second end, the interior surface bounding a compartment, a plurality of first passages extending through the second end of the pre-chamber, the second end of the pre-chamber being aligned the pre-chamber relief.

24. The combustion system as recited in claim 23, wherein a least a portion of the second end of the pre-chamber is disposed within pre-chamber relief when the piston is in the raised top dead center position.

25. The combustion system as recited in claim 23, wherein the transverse cross sectional area of the pre-chamber relief is substantially oval or elliptical.

26. The combustion system as recited in claim 23, wherein the crown of the piston further comprises:
a substantially planar plateau surface on which the pre-chamber relief is recessed, the planar plateau surface having a front edge and an opposing back edge;
a first valve relief surface sloping away from the front edge of the planar plateau surface; and
a second valve relief surface sloping away from the back edge of the planar plateau surface.

27. The combustion system as recited in claim 26, wherein the first valve relief surface and the second valve relief surface are both substantially planar.

28. The combustion system as recited in claim 23, wherein the crown of the piston further comprises:
the pre-chamber relief having a front edge and an opposing back edge;
a first valve relief surface sloping away from the front edge of the pre-chamber relief; and
a second valve relief surface sloping away from the back edge of the pre-chamber relief.

29. A piston for an internal combustion engine, the piston comprising:
a substantially cylindrical body extending between a first end and an opposing second end;
a crown formed at a terminal end face at the first end of the body and extending to a perimeter edge, the crown comprising:
a recessed pre-chamber relief;
a first ledge having a top surface disposed adjacent to the perimeter edge;
a first valve relief surface disposed between the pre-chamber relief and the first ledge; and
an elongated first outside ramp surface having a curved transverse cross section formed between the first valve relief surface and top surface of the first ledge.

30. The piston as recited in claim 29, wherein the first outside ramp surface has a height extending between the first valve relief surface and top surface of the first ledge in a range between about 1 mm to about 3 mm.

31. The piston as recited in claim 29, wherein the first outside ramp surface is concave.

32. The piston as recited in claim 29, wherein the first outside ramp surface linearly extends between two spaced apart locations on the perimeter edge.

33. The piston as recited in claim 29, wherein the first outside ramp surface linearly extends between two spaced apart locations but does not extend to the perimeter edge.

34. The piston as recited in claim 29, further comprising:
the first outside ramp surface extending between a first end and an opposing second end;
a first fillet upstanding at the first end of the first outside ramp surface; and
a second fillet upstanding at the second end of the first outside ramp surface.

35. The piston as recited in claim 29, wherein top surface of the first ledge is substantially planar and the first valve relief surface is substantially planar, the first valve relief surface being sloped relative to the top surface of the first ledge.

36. The piston as recited in claim 29, wherein the crown of the piston further comprises:
a second ledge having a top surface disposed adjacent to the perimeter edge, the second ledge being disposed on a side of the crown opposite the first ledge;
a second valve relief surface disposed between the pre-chamber relief and the second ledge; and
an elongated second outside ramp surface having a curved transverse cross section formed between the second valve relief surface and top surface of the second ledge.

37. A piston for an internal combustion engine, the piston comprising:
a substantially cylindrical body extending between a first end and an opposing second end;
a crown formed at a terminal end face at the first end of the body, the crown comprising:
a central plateau surface that is substantially planar;
a pre-chamber relief recess on the central plateau;
a first ledge having a top surface disposed adjacent to the perimeter edge; and
a first valve relief surface disposed between the pre-chamber relief and the first ledge, the first valve relief surface being sloped relative to the central plateau surface and the top surface of the first ledge.

38. The piston as recited in claim 37, wherein the pre-chamber relief has an elongated transverse cross section.

39. The piston as recited in claim 37, further comprising:
a second ledge having a top surface disposed adjacent to the perimeter edge at a side of the piston opposite the first ledge; and
a second valve relief surface disposed between the pre-chamber relief and the second ledge, the second valve relief surface being sloped relative to the central plateau surface and the top surface of the second ledge.
